(19) United States
(12) Patent Application Publication
(10) Pub. No.: US 2017/0003904 A1
(43) Pub. Date: Jan. 5, 2017

(54) ELECTRONIC APPARATUS AND POWER MANAGEMENT METHOD FOR SOLID STATE DISK THEREOF

(71) Applicant: Acer Incorporated, New Taipei City (TW)

(72) Inventors: Tz-Yu Fu, New Taipei City (TW); Hsin-Yu Chen, New Taipei City (TW)

(21) Appl. No.: 15/182,270

(22) Filed: Jun. 14, 2016

(30) Foreign Application Priority Data
Jun. 30, 2015 (TW) 104121128

(51) Int. Cl. G06F 3/06

(52) U.S. Cl. CPC G06F 3/0625; G06F 3/0679; G06F 3/0655

(57) ABSTRACT

An electronic apparatus and a power management method for a solid state disk thereof are provided. The solid state disk includes a controller and multiple memory dies which are separated into multiple channels. In the method, the solid state disk uses the channels corresponding to one of at least one power state to provide parallel data processing, in which the at least one power state is set in the controller of the solid state disk, each power state only uses a portion of the channels to provide parallel data processing at one time, and a quantity of the channels used by the at least one power state is different.

### CROSS-REFERENCE TO RELATED APPLICATION

This application claims the priority benefit of Taiwan application serial no. 104121128, filed on Jun. 30, 2015. The entirety of the above-mentioned patent application is hereby incorporated by reference herein and made a part of this specification.

### TECHNICAL FIELD

The disclosure is related to an electronic device and a power management method thereof, and particularly to a power management method of an electronic device and a solid state disk of the electronic device.

### BACKGROUND

For a solid state disk (SSD) using a peripheral component interconnect express (PCI-E) interface, high power consumption during the actual read and write operations are one of the critical problem in the field. As compared to a storage device using serial advanced technology attachment (SATA) interface which consumes about 2-3 W, the solid state disk using PCI-E interface may consume more than 10 W while the solid state disk using PCI-E interface reads or writes in its full speed. Such instantaneous thermal raise may cause users to have burning sensation.

For the power management of the solid state disk, non-volatile memory express (NVMe) defines power state for the manufacturers to apply. Unless the solid state disk is in non-operation state (i.e. Non-OP state), there are designs having operation states that allow the power consumption of the NVMe device to be effectively suppressed.

However, techniques such as rapid storage technology (RST) of Intel Corporation has not prefect the design for the operation state of the solid state disk. When the solid state disk is reading or writing data, all of the channels would be enabled to achieve the highest data transmission, which results in an unavoidable high power consumption.

### SUMMARY

The disclosure provides an electronic device and a power management of a solid state disk of the electronic device. The solid state disk may be controlled to use all or a portion of channels to provide data parallel processing according to a hardware and software usage of the electronic device.

According to an embodiment of the disclosure, a power management method of a solid state disk, adapted to an electronic device having the solid state disk, is provided. The solid state disk comprises a controller and a plurality of memory dies which are separated into a plurality of channels. The method includes using the channels corresponding to one of at least one power state to provide parallel data processing, wherein the at least one power state is set in the controller of the solid state disk, each of the at least one power state only uses a portion of the channels to provide parallel data processing at one time, and the quantity of the channels used by each of the at least one power state is different.

According to an embodiment of the disclosure, an electronic device includes a solid state disk. The solid state disk includes a controller and a plurality of memory dies which are separated into a plurality of channels, where at least one power state is set in the controller of the solid state disk, and the channels corresponding to one of the at least one power state are used for data parallel processing, the at least one power state only uses a portion of the channels to provide data parallel processing at one time, and the quantity of the channels used by each of the at least one power state is different.

Based on the above, an electronic device and a power management of the solid state disk is provided by configuring a plurality of power states in a controller of the solid state disk, and each of the power states utilizes all of or a portion of the channels to provide data parallel processing. Accordingly, the electronic device may enable an appropriate quantity of channels to provide data access according to the power state of the solid state disk switched according to a hardware and software usage of the electronic device. Thereby, the electronic device any obtain a balance between performance and power consumption for accessing the solid state disk.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram illustrating an electronic device according to an exemplary embodiment of the disclosure.

FIG. 2 is a flowchart illustrating a power management method of a solid state disk according to an exemplary embodiment of the disclosure.

FIG. 3 is a flowchart illustrating a power management method of a solid state disk according to an exemplary embodiment of the disclosure.

FIG. 4 is diagram illustrating a power management method of the solid state disk according to an exemplary embodiment of the disclosure.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The disclosure configures a plurality of power states for a solid state disk, where each of the power states corresponds to different quantity of channels. The power state of the solid state disk may be switched based on the hardware and software usage of an electronic device as to enable appropriate quantity of channels for the electronic device to access data. Thereby, not only instantaneous high power consumption of the electronic device is avoided, power consumption of the electronic device may be appropriately adjusted as to balance between access performance and power consumption.

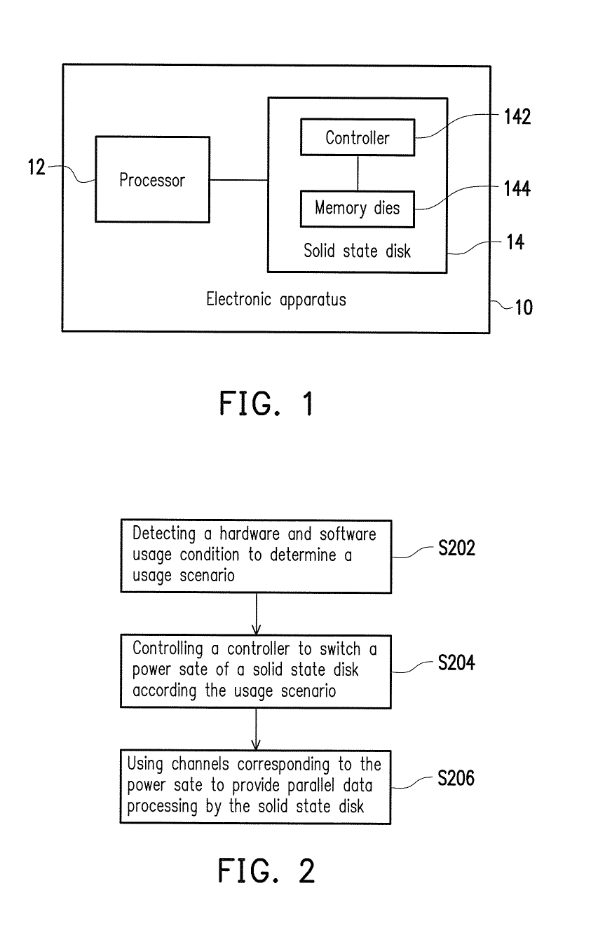

FIG. 1 is a block diagram illustrating an electronic device according to an exemplary embodiment of the disclosure. With reference to FIG. 1, an electronic device 10 of the embodiment is, for example, a device utilizes a solid state disk 14 as data storage medium and a battery for power source, such as but not limited to notebook computer, tablet computer, smart phone, or other multimedia devices. Since these devices have limited power resource, power management is required, especially for the solid state disk 14 which has high power consumption. The electronic device 10 includes a processor 12 and the solid state disk 14, and their functions are respectively described below.

The processor 12 is, for example, a Central Processing Unit (CPU) having single core or multiple cores, any programmable microprocessor for general or special purposes, a Digital Signal Processor (DSP), a programmable controller, an Application Specific Integrated Circuit (ASIC) or the likes or any combination of the aforementioned components. In the present exemplary embodiment, the processor 110 is configured to process all of the operations for the processing device 100 of the exemplary embodiment.

The solid state disk 14 includes a controller 142 and a plurality of memory dies 144. The controller 42 is, for example, an embedded controller (EC) or a control chip. The memory dies 144 are, for example, dies adopting NAND Flash memory or other non-volatile memory, which may be separated into a plurality of channels. Through the control of the controller 142, the channels may be partially or entirely provided for the processor 12 to access data stored in the memory dies 144.

In contrast to the conventional solid state disk that enables all of the channels, the controller 142 of the present exemplary embodiment may utilize an operation state (OP State) designed by Non-Volatile Memory Express (NVMe) community to configure a plurality of power states to the solid state disk 14. For example, the controller 142 may configure a preset operational state of the solid state disk 14 to a power state PS0. Under such power state, the solid state disk 14 may provide 8 channels to the processor 12 for data access. Furthermore, the controller 142 may additionally configure power states PS1 and PS 2, which may provide parallel data processing with 4 channels and 2 channels, respectively. The processor 12 may determine a usage scenario of the electronic device 10 according to current hardware and software condition of the electronic device 10, and accordingly control the controller 142 to switch power state so as to provide an appropriate quantity of channels to the processor for data access.

In detail, FIG. 2 is a flowchart illustrating a power management method of a solid state disk according to an exemplary embodiment of the disclosure. With reference to FIGS. 1 and 2, the method of the present exemplary embodiment is adapted to the electronic device 10 described above. In the following, the processing flow of the method is described in detail accompanying with each component of the electronic device 10 illustrated in FIG. 1.

Firstly, the processor 12 detects the hardware and software usage of the electronic device 10 to determine a usage scenario (step S202). According to the determined usage scenario, the processor 12 further control the controller 142 of the solid state disk 14 to switch a power state of the solid state disk 14 (step S204). Here, the hardware and software usage scenario refers to various factors within the electronic device 10 that may affect the power consumption of the electronic device 10, which may be categorized into a hardware portion and a software portion.

For example, in an exemplary embodiment, the processor 12 may detect a power source of the electronic device 10 to determine the usage scenario. If the process 12 detects that the electronic device 10 is using a power adapter as the power source, it may be determined that there is no immediate need for power management. Therefore, the controller 142 of the solid state disk 14 may switch the power state of the solid state disk 14 to the power state PS0 as described in the above exemplary embodiment. On the contrary, if the processor 12 detects that the electronic device 10 is using a battery as power source. Since the power of the battery is limited, the power management is needed to reduce power consumption. The controller 142 of the solid state disk 14 switches the power state of the solid state disk 14 to the power state PS1 or PS 2 as described in the above exemplary embodiment.

In another exemplary embodiment, the processor 12 detects the types of currently executed application programs and the quantity of the currently executed application programs, so as to determine the usage scenario. If the processor 12 determines that the electronic device 10 is currently executing benchmark software or game software having high access demand to the solid state disk 14, which requires the solid state disk 14 to provide all of the channels for data access, the controller 142 of the solid state disk 14 then switches the power state of the solid state disk 14 to the power state PS0 as described in the above exemplary embodiment. On the contrary, if the processor 12 detects that the electronic device 10 merely executes a word processing software having lower power demand, the controller 142 of the solid state disk 14 then switches the power state of the solid state disk 14 to the power state PS1 or PS2 as described in the above exemplary embodiment, so as to conserve power and lower device temperature.

After the power state is switched, the solid state disk 14 uses the channels corresponding to the power state to provide parallel data processing. Using the power states PS0-PS2 which described in the above exemplary embodiment as example, if the solid state disk 14 is switched to the power state PS0, 8 channels are provided to the processor 12 for access operation. If the solid state disk 14 is switched to the power state PS1, 4 channels are provided to the processor 12 for access operation. If the solid state disk 14 is switched to PS2, only 2 channels are provided at one time to the process 12 for access operation. Assuming the power consumption of 8 channels is 10 W, when the quantity of channels is reduced to 4 channels, the power consumption thereof is reduced to 5 W, approximately; and when the quantity of channels is reduced to 2 channels, the power consumption is further reduced to 2.5 W. In this way, utilization of all channels by the solid state disk 14 under all conditions, which causes high power consumption, may be avoid.

It should be noted that, in addition to the switching of the power states to adjust the quantity of channels for data access, the disclosure further includes adjustment for the quantity and an access order (or sequence) of the channels to be utilized according to a location of the data to be accessed by the electronic device 10 in the solid state disk 14 and the access order which the data is to be accessed with. In the following, an exemplary embodiment is illustrated to describe the above.

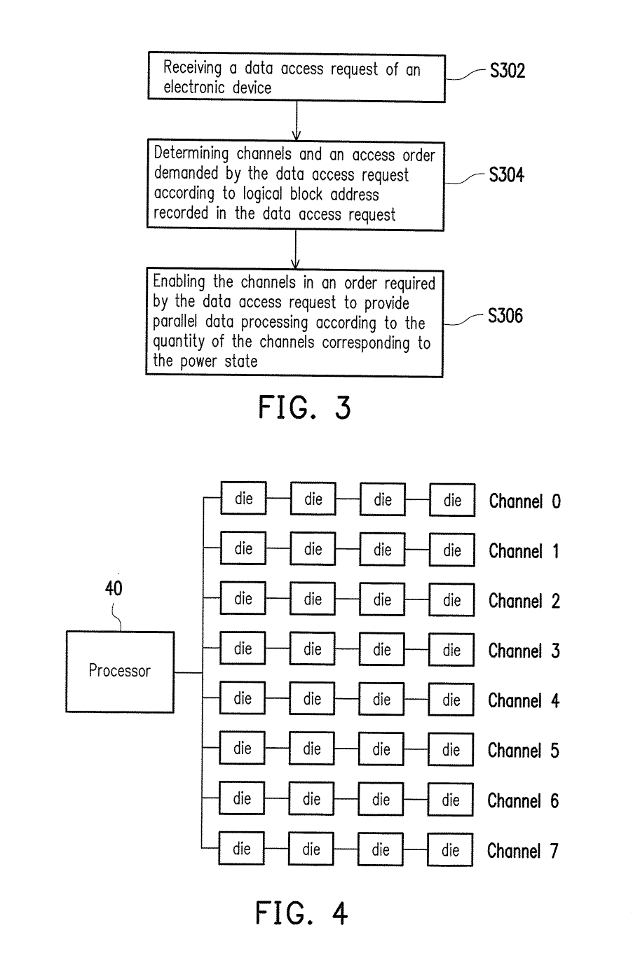

FIG. 3 is a flowchart illustrating a power management method of a solid state disk according to an exemplary embodiment of the disclosure. With reference to FIGS. 1 and 3, the method of the exemplary embodiment would describe the step S206 illustrated in FIG. 2 in detail.

In detail, after switching the power state of the solid state disk 14, the controller 142 may receive a data access request of the processor 12 (step S302). The channels required for data access and the access order for the data access request may be determined according to logical block address (LBA) of the data to be accessed recorded in the data access request (step S304). Afterward, the controller 142 would enable the channels in an order required by the data access request to provide parallel data processing according to the quantity of the channels corresponding to the power state which the solid state disk 14 is switched to (step S306). When one of the channels enabled by the controller 142 completes the data processing, the controller 132 would disable this channel and enables the subsequent channel in the sequence of the access order for data access. With such channel rotation process, the solid state disk 14 would have only 4 channels enabled simultaneously at one time, which reduces the power consumption as opposed to the power consumed by all of the channels being enabled at the same time.

For example, FIG. 4 is diagram illustrating a power management method of the solid state disk according to an exemplary embodiment of the disclosure. With reference to FIG. 4, in the present exemplary embodiment, a controller 40 of the solid state disk is connected to the memory dies of 8 channels (i.e. channels 0-7). In the initial power state, 8 channels are enabled for data access simultaneously. When the power state is switched to using only 4 channels, controller 40 may, for example, interpret from the data access request of the electronic device that the logical block address of the data to be accessed corresponds to the memory dies in channels 1-5. The order of data access may start from channel 1, and then channel 2, channel 3, channel 4, and channel 5. At this time, the controller 40 may first enable channels 1-4 and disable channels 0 and 5-7, so that the electronic device may simultaneously access the data stored in the memory dies in channels 1-4. When the data access in channel 1 is completed and the data access in channels 2-4 are still in progress, the controller 40 may disable channel 1 and enable channel 5. In this way, the controller 40 may maintain only 4 channels operational at the same time in this power state, so as to reduce the power consumption as oppose to all of the channels being enabled.

It should be noted that, in the above exemplary embodiment, the processor of the electronic device may switch the power state of the solid state disk only when the solid state disk is in an non-operational state (Non-OP state) or returning from the operational state to the Non-OP state (i.e. no data access). If the processor detects that the hardware and software usage of the electronic device has changed and requires to adjust the power state of the solid state disk, the processor may wait until the current data access is completed and the solid state disk is returned to the non-OP state and then switch the power state of the solid state disk for subsequent data access.

In summary, an electronic device and a power management thereof in the present disclosure configures a plurality of power states for a solid state disk and defines the quantity of channels to be enabled by the solid state disk under each of the power states. In this way, the electronic device may instantaneously switch the power state of the solid state disk according to current hardware and software usage, so as to obtain a balance between the performance and power consumption for data access. Furthermore, the disclosure further determines a location of the data to be accessed in the solid state disk according to logical block address of the data to be accessed corresponding to the data access request of the electronic device, so as to enable the channels containing the data in an order, so as to conserve the power which would otherwise be consumed by enabling unnecessary channels.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A power management method of a solid state disk, adapted to an electronic device having the solid state disk, wherein the solid state disk comprise a controller and a plurality of memory dies which are separated into a plurality of channels, and the method comprises:
using the channels corresponding to one of at least one power state to provide parallel data processing by the solid state disk, wherein the at least one power state is set in the controller of the solid state disk, each of the at least one power state only uses a portion of the channels to provide parallel data processing at one time, and the quantity of the channels used by each of the at least one power state is different.

2. The method as claimed in claim 1, further comprising:
detecting a power source of the electronic device to determine a usage scenario, wherein the power source comprises a power adapter and a battery; and
controlling the controller to switch the power state of the solid state disk according to the usage scenario.

3. The method as claimed in claim 1, further comprising:
detecting types of currently executed application programs and a quantity of the currently executed application programs to determine a usage scenario; and
controlling the controller to switch the power state of the solid state disk according to the usage scenario.

4. The method as claimed in claim 1, wherein the step of using the channels corresponding to one of at least one power state to provide parallel data processing by the solid state disk comprises:
receiving a data access request of the electronic device;
determining the channels and the access order required by the data access request according to logical block address recorded in the data access request; and
enabling the channels in an order required to be accessed by the data access request to provide data parallel processing according to the quantity of the channels corresponding to the at least one power state.

5. The method as claimed in claim 4, wherein the step of using the channels corresponding to one of at least one power state to provide parallel data processing comprises:
every time when one of the enabled channels is completed with data processing, disabling the channel completed with the data processing, and enabling a subsequent channel among the channels corresponding to the data access request to provide data access according to the access order.

6. An electronic device, comprising:
a solid state disk, comprising a controller and a plurality of memory dies which are separated into a plurality of channels, wherein at least one power state is set in the controller of the solid state disk, and the channels corresponding to one of the at least one power state are used for data parallel processing, the at least one power state only uses a portion of the channels to provide data parallel processing at one time, and the quantity of the channels used by each of the at least one power state is different.

7. The electronic device as claimed in claim 6, further comprises:
a processor, coupled to the solid state disk, and configured to detect a power source of the electronic device to determine a usage scenario, and control the controller of the solid state disk to switch the power state of the solid state disk according to the usage scenario, wherein the power source comprises a power adapter and a battery.

8. The electronic device as claimed in claim 6, further comprising:
a processor, coupled to the solid state disk, and configured to detect types of currently executed application programs and the quantity of the currently executed application programs to determine the usage scenario, and control the controller of the solid state disk to switch the power state of the solid state disk according to the usage scenario.

9. The electronic device as claimed in claim 6, wherein the controller receives a data access request of the electronic device, and determines the channels and an access order corresponding to the data access request according to logical block address recorded in the data access request, and further enables the channels corresponding to the data access request to provide data parallel processing according to the quantity of the channels corresponding to the at least one power state, wherein every time when one of the enabled channels is completed with data processing, the controller disables the channel completed with the data processing and enables a subsequent channel among the channels corresponding to the data access request to provide data access according to the access order.

10. The electronic device as claimed in claim 6, wherein the memory dies are separated to 8 channels, the at least one power state comprises a first state using 8 channels, a second state using 4 channels, and a third state using 2 channels.
